(19) United States
(12) Patent Application Publication
(10) Pub. No.: US 2011/0045278 A1
(43) Pub. Date: Feb. 24, 2011

(54) Filling foam composition and foam filling member

(75) Inventors: Atsushi Kuriu, Osaka (JP); Yoshiaki Mitsuoka, Osaka (JP)

Correspondence Address: AKERMAN SENTERFITT, 8100 BOONE BOULEVARD, SUITE 700, VIENNA, VA, 22182-2683, US

(73) Assignee: Nitto Denko Corporation, Osaka (JP)

(21) Appl. No.: 12/805,777

(22) Filed: Aug. 19, 2010

(30) Foreign Application Priority Data
Aug. 20, 2009 (JP) 2009-191279

(51) Int. Cl. B32B 3/26; C08L 63/00

(52) U.S. Cl. 428/304.4; 521/50; 521/135; 521/178

(57) ABSTRACT

Provided is a filling foam composition for filling a gap between members by foaming. The filling foam composition has a heat sagged length of 14 mm or less in (1) heat sag test without any breakage caused by (2) impact test.

### CROSS-REFERENCE TO RELATED APPLICATION

The present application claims priority from Japanese Patent Application No. 2009-191279 filed on Aug. 20, 2009, the content of which is hereby incorporated by reference into this application.

### BACKGROUND OF THE INVENTION

1. Field of the Invention

The present invention relates to a filling foam composition and a foam filling member, and more specifically to a filling foam composition used for filling a gap between various members, and a foam filling member including the same.

2. Description of Related Art

In automobiles, in order to reinforce steel plates of automobile bodies, it has been conventionally known to fill a gap between the steel plates with a foam.

There has been proposed that, for example, a heat-foamable filling reinforcement member containing an epoxy resin, a foaming agent, and a curing agent is formed into a sheet-like shape, the sheet-shaped member is attached to the inner portion of a closed-section structural member, and the attached member is subsequently foamed to be cured by heating under the same conditions as that for baking finish, whereby the foam fills the inner portion of the closed-section structural member (cf. Japanese Unexamined Patent Publication No. 8-198995).

### SUMMARY OF THE INVENTION

However, the heat-foamable filling reinforcement member described in Japanese Unexamined Patent Publication No. 8-198995 is not sufficiently resistant to heat sagging, resulting in occurrence of heat sagging that the heat-foamable filling reinforcement member runs downward (sags) upon heating under the above conditions, thereby failing to uniformly and reliably fill the inner portion of the closed-section structural member.

The heat-foamable filling reinforcement member of Japanese Unexamined Patent Publication No. 8-198995 may produce a fracture or a crack due to vibration or dropping during transportation before attachment to the steel plate of an automobile, or during the attachment. In such case, the handleability as a sheet deteriorates, making it difficult to securely attach the heat-foamable filling reinforcement member to the inner portion of the closed-section structural member.

It is an object of the present invention to provide a filling foam composition having excellent heat sagging resistance and excellent impact resistance, and a foam filling member including the same.

The filling foam composition of the present invention is a filling foam composition for filling a gap between members by foaming, has a heat sagged length of 14 mm or less in the following (1) heat sag test, without any breakage caused by the following (2) impact test:

(1) Heat Sag Test

The filling foam composition is processed into a rectangular sheet shape having a thickness of 3 mm, a length of 100 mm, and a width of 50 mm, to obtain a test piece.

Subsequently, the test piece is adhered to one lengthwise side surface of a cold rolled steel plate having a rectangular sheet shape of a length of 300 mm and a width of 150 mm via an adhesive tape. A 2 kg roller is then reciprocated on the test piece once along the lengthwise direction, and the test piece is allowed to stand for 30 minutes.

Thereafter, the test piece and the cold rolled steel plate are disposed so that the lengthwise direction of the test piece lies along the vertical direction and that the test piece is positioned in the upper portion of the cold rolled steel plate, and then are heated at 150° C. for 30 minutes.

After the heated test piece is air-cooled to room temperature, the length of the lower edge of the test piece sagged downward is measured.

(2) Impact Test

The filling foam composition is processed into a rectangular sheet shape having a thickness of 3 mm, a length of 100 mm, and a width of 50 mm, to obtain a test piece.

A test stand provided with a underplate having the same length and the same width as the test piece and two ridges protruded upward from the underplate in the thickness direction is prepared separately. The two ridges are opposed to each other at a spaced interval of 80 mm in the lengthwise direction, and extends in parallel along the widthwise direction orthogonal to the protruded direction and to the opposed direction, each of the ridges being formed in the shape of a rectangular cross-sectional beam having a length of 10 mm in the protruded direction, a length of 5 mm in the opposed direction, and a widthwise length of 50 mm.

Thereafter, the test piece is placed on the upper surfaces of the two ridges on the test stand so as to be disposed in the same position as the underplate when projected in the thickness direction.

Next, an iron ball weighing 110 g is let fall from 10 cm above the center of the upper surface of the test piece, and the presence or absence of breakage of the test piece is observed.

It is preferable that the filling foam composition of the present invention includes a modified epoxy resin and fiber, that the modified epoxy resin is one obtained by modifying a bisphenol A type epoxy resin with a carboxyl terminal acrylonitrile-butadiene copolymer, and that the fiber is an aromatic polyamide fiber.

In the filling foam composition of the present invention, it is preferable that the modified epoxy resin is blended in a proportion of 20 to 70 parts by weight per 100 parts by weight of the filling foam composition.

It is preferable that the filling foam composition of the present invention further includes a resin except a modified epoxy resin and that the resin is an ethylene-vinyl acetate copolymer and/or an epoxy resin.

In the filling foam composition of the present invention, it is preferable that the resin is blended in a proportion of 5 to 40 parts by weight per 100 parts by weight of the modified epoxy resin.

In the filling foam composition of the present invention, it is preferable that the member is a steel plate of an automobile.

The filling foam composition of the present invention has excellent impact resistance. Therefore, such property can prevent the filling foam composition from being damaged due to vibration or dropping during transportation before attachment to a member or during the attachment, thereby allowing its given shape to be reliably maintained and to be securely attached to the member. As a result, the foam of the filling foam composition can be reliably filled in the gap between the members with heating.

The filling foam composition of the present invention has excellent heat sagging resistance. Therefore, heat sagging during heating is suppressed, and the foam of the filling foam composition can be uniformly and reliably filled in the gap between the members.

The foam filling member of the present invention includes a filling foam member made of a filling foam composition for filling a gap between members by foaming; and a mounting member mounted on the filling foam member, attachable to the gap between members and made of a non-foamable composition which is not foamed with heat, in which the filling foam composition has a heat sagged length of 14 mm or less in the following (1) heat sag test, without any breakage caused by the following (2) impact test:

(1) Heat Sag Test

The filling foam composition is processed into a rectangular sheet shape having a thickness of 3 mm, a length of 100 mm, and a width of 50 mm, to obtain a test piece.

Subsequently, the test piece is adhered to one lengthwise side surface of a cold rolled steel plate having a rectangular sheet shape of a length of 300 mm and a width of 150 mm via an adhesive tape. A 2 kg roller is then reciprocated on the test piece once along the lengthwise direction, and the test piece is allowed to stand for 30 minutes.

Thereafter, the test piece and the cold rolled steel plate are disposed so that the lengthwise direction of the test piece lies along the vertical direction and that the test piece is positioned in the upper portion of the cold rolled steel plate, and then are heated at 150° C. for 30 minutes.

After the heated test piece is air-cooled to room temperature, the length of the lower edge of the test piece sagged downward is measured.

(2) Impact Test

The filling foam composition is processed into a rectangular sheet shape having a thickness of 3 mm, a length of 100 mm, and a width of 50 mm, to obtain a test piece.

A test stand provided with a underplate having the same length and the same width as the test piece and two ridges protruded upward from the underplate in the thickness direction is prepared separately. The two ridges are opposed to each other at a spaced interval of 80 mm in the lengthwise direction, and extends in parallel along the widthwise direction orthogonal to the protruded direction and to the opposed direction, each of the ridges being formed in the shape of a rectangular cross-sectional beam having a length of 10 mm in the protruded direction, a length of 5 mm in the opposed direction, and a widthwise length of 50 mm.

Thereafter, the test piece is placed on the upper surfaces of the two ridges on the test stand so as to be disposed in the same position as the underplate when projected in the thickness direction.

Next, an iron ball weighing 110 g is let fall from 10 cm above the center of the upper surface of the test piece, and the presence or absence of breakage of the test piece is observed.

The filling foam member of the present invention allows the foam of the filling foam member made of a filling foam composition, which is excellent in impact resistance and heat sagging resistance, to be uniformly and reliably filled in the gap between the members.

### BRIEF DESCRIPTION OF THE DRAWINGS

FIG. 1 is an explanatory view of a method of attaching one embodiment of a foam filling member of the present invention, including a filling foam member made of a filling foam composition of the present invention, to steel plates, and filling a gap between the steel plates by foaming,

(a) showing the step of preparing a foam filling member and two steel plates to insert the foam filling member into the gap between the steel plates,

(b) showing the step of attaching a mounting member to the steel plates, and

(c) showing the step of foaming the filling foam member by heating;

FIG. 2 is a perspective view for explaining a heat sag test; and

FIG. 3 is a perspective view for explaining an impact test,

(a) showing the step of preparing a test piece and a test stand; and

(b) showing the step of placing the test piece on the upper surfaces of ridges of the test stand, and then dropping an iron ball toward the test piece.

### DETAILED DESCRIPTION OF PREFERRED EMBODIMENTS

The filling foam composition of the present invention is a filling foam composition for filling a gap between members by foaming. Specifically, the filling foam composition essentially contains, for example, a modified epoxy resin and a fiber, and optionally contains a resin (resin other than the above-mentioned modified epoxy resin), a filler, a foaming agent, and a curing agent.

The modified epoxy resin is blended in order to improve impact resistance of the filling foam composition, and specifically, is a modified resin obtained by modifying an epoxy resin (raw material) with a modifying agent.

The epoxy resins include, for example, bisphenol epoxy resin (e.g., bisphenol A type epoxy resin, bisphenol F type epoxy resin, bisphenol S type epoxy resin, hydrogenated bisphenol A type epoxy resin, dimer acid modified bisphenol epoxy resin, etc.), novolak epoxy resin (e.g., phenol novolak epoxy resin, cresol novolak epoxy resin, etc.), cyclo aliphatic epoxy resin (e.g., dicyclo ring type epoxy resin, etc.), biphenyl epoxy resin, naphthalene epoxy resin, glycidyl ester epoxy resin, and glycidyl amine epoxy resin.

These epoxy resins can be used alone or in combination of two or more kinds.

Of these epoxy resins, a bisphenol epoxy resin is preferably used, or a bisphenol A type epoxy resin is more preferably used.

The modifying agents include, for example, rubbers such as acrylonitrile-butadiene copolymer, urethane rubber, polyether rubber, polysulfide rubber, and polybutadiene-polyisoprene-polyacrylonitrile butadiene copolymer; silicone; and unsaturated fatty acid (including unsaturated fatty acid which contains a conjugated double bond in its molecule). Of these, rubber is preferably used.

Each of these modifying agents has a functional group (e.g., a carboxyl group, an amino group, a hydroxyl group, etc.) which reacts with an epoxy resin at its molecular terminal, and the functional group is allowed to react with an epoxy resin to thereby modify the epoxy resin.

Specific examples of the modified epoxy resin include rubber-modified epoxy resins such as acrylonitrile-butadiene copolymer modified epoxy resin, urethane-modified epoxy resin, polyether-modified epoxy resin, polysulfide-modified epoxy resin, and polybutadiene-polyisoprene-polyacrylonitrile butadiene copolymer modified epoxy resin; silicone-modified epoxy resin; and unsaturated fatty acid modified epoxy resin.

Of these, a rubber-modified epoxy resin is preferably used.

More specifically, as the modified epoxy resin, acrylonitrile-butadiene copolymer modified bisphenol A type epoxy resin obtained by modifying a bisphenol A type epoxy resin with a carboxyl terminal acrylonitrile-butadiene copolymer is preferably used.

These modified epoxy resins can be used alone or in combination of two or more kinds.

Epoxy equivalent of the modified epoxy resin ranges, for example, from 100 to 3000 g/eqiv., or preferably 500 to 2000 g/eqiv.

The fiber is blended in order to improve heat sagging resistance of the filling foam composition. Specifically, the fibers include, for example, organic fibers such as aromatic polyamide fiber and polyester fiber; and inorganic fibers such as glass fiber, ceramic fiber, alumina fiber, and carbon fiber.

Of these, organic fibers are preferably used, or aromatic polyamide fiber, is more preferably used in terms of heat resistance.

The aromatic polyamides that may be used for forming an aromatic polyamide fiber include, for example, para-type aromatic polyamide such as copoly-paraphenylene-3,4′-oxydiphenylene-terephthalamide and poly(p-phenyldiamine terephthalamide); and meta-type aromatic polyamide such as poly-meta-phenylene isophthalamide. Of these, para-type aromatic polyamide is preferably used.

The fiber has a density (specific gravity) of, for example, 1.0 to 2.0 g/cm³, or preferably 1.2 to 1.8 g/cm³, a mean fiber length of, for example, 0.5 to 2.5 mm, or preferably 1.0 to 2.0 mm, and a Young's modulus of, for example, 30 to 120 GPa, or preferably 40 to 100 GPa. The Young's modulus of the fiber is measured according to ASTM D885-85.

Concerning the components essentially contained in the filling foam composition, per 100 parts by weight of the filling foam composition, the modified epoxy resin is blended in the proportion of, for example, 20 to 70 parts by weight, or preferably 30 to 60 parts by weight, and the fiber is blended in the proportion of, for example, 0.2 to 2.0 parts by weight, or preferably 0.4 to 1.0 part by weight.

Less than the above proportion of the modified epoxy resin may fail to sufficiently improve the impact resistance. On the contrary, more than the above proportion of the modified epoxy resin leads to less than the above proportion of the fiber, which may fail to sufficiently improve the heat sagging resistance.

The resins that may be used include, for example, ethylene-vinyl acetate copolymer (EVA), ethylene-ethyl acrylate copolymer (EEA), ethylene-butyl acrylate copolymer (EBA), olefin resin (e.g., polyethylene, polypropylene, etc.), polyester, polyvinyl butyral, polyvinyl chloride, epoxy resin (epoxy resins except the above-mentioned modified epoxy resins).

These resins can be used alone or in combination of two or more kinds.

Of these, EVA and epoxy resin are preferably used.

EVA is a copolymer of ethylene and vinyl acetate, and the content of the vinyl acetate (VA content) ranges, for example, from 10 to 46% by weight.

As the epoxy resin, for example, the same epoxy resin as those exemplified as a raw material of the above-mentioned modified epoxy resin is used, and a bisphenol A type epoxy resin and a hydrogenated bisphenol A type epoxy resin are preferably used. Such epoxy resin is, for example, in liquid form, and epoxy equivalent of the epoxy resin ranges, for example, from 180 to 1200 g/eqiv., or preferably 200 to 800 g/eqiv.

Each of the components in the resin is blended in a proportion of, for example, 5 to 40 parts by weight, or preferably 10 to 35 parts by weight, per 100 parts by weight of the modified epoxy resin.

The fillers include, for example, calcium carbonate (e.g., calcium carbonate heavy, calcium carbonate light, Hakuenka (R) (colloidal calcium carbonate), etc.), talc, mica, clay, mica powder, bentonite, silica, alumina, aluminum silicate, titanium oxide, aluminum powder, and glass powder. These fillers can be used alone or in combination of two or more kinds.

The filler is blended in a proportion of, for example, 30 to 200 parts by weight, or preferably 50 to 160 parts by weight, per 100 parts by weight of the modified epoxy resin.

The foaming agents that may be used include, for example, thermally decomposable foaming agents such as inorganic foaming agents and organic foaming agents.

The inorganic foaming agents include, for example, ammonium carbonate, ammonium hydrogen carbonate, sodium hydrogen carbonate, ammonium nitrite, sodium borohydride, and azides.

The organic foaming agents include, for example, an N-nitroso compound (N,N′-dinitrosopentamethylenetetramine, N,N′-dimethyl-N,N′-dinitrosoterephthalamide, etc.), an azoic compound (e.g., azobis isobutyronitrile, azodicarboxylic amide (ADCA), barium azodicarboxylate, etc.), alkane fluoride (e.g., trichloromonofluoromethane, dichloromonofluoromethane, etc.), a hydrazine compound (e.g., paratoluene sulfonyl hydrazide, diphenylsulfone-3,3′-disulfonyl hydrazide, 4,4′-oxybis (benzene sulfonyl hydrazide) (OBSH), allylbis (sulfonyl hydrazide), etc.), a semicarbazide compound (e.g., p-toluoylenesulfonyl semicarbazide, 4,4′-oxybis(benzene sulfonyl semicarbazide, etc.), and a triazole compound (e.g., 5-morphoryl-1,2,3,4-thiatriazole, etc.).

As the foaming agent, for example, a gas-filled microcapsule foaming agent can be used. More specifically, the foaming agents can be in the form of thermally expansive microparticles including microcapsules formed by encapsulating thermally expansive material (e.g., isobutane, pentane, etc.) in a microcapsule (e.g., microcapsule of thermoplastic resin such as vinylidene chloride, acrylonitrile, acrylic ester, and methacrylic ester).

These foaming agents can be used alone or in combination of two or more kinds.

Of these, an organic foaming agent is preferably used, or a hydrazine compound is more preferably used.

The foaming agent is blended in a proportion of, for example, 0.2 to 5 parts by weight, or preferably 0.3 to 3 parts by weight, per 100 parts by weight of the modified epoxy resin.

As the curing agent, for example, a thermally curable type curing agent is used.

The curing agents that may be used include, for example, amine compounds, acid anhydride compounds, amide compounds, hydrazide compounds, imidazole compounds, and imidazoline compounds. In addition to these, phenol compounds and polysulfide compounds can be used as the curing agent.

The amine compounds include, for example, ethylenediamine, propylenediamine, diethylenetriamine, triethylenetetramine, amine adducts thereof, metaphenylenediamine, diaminodiphenylmethane, diaminodiphenylsulfone, and 12-aminododecanoic acid.

The acid anhydride compounds include, for example, phthalic anhydride, maleic anhydride, tetrahydrophthalic anhydride, hexahydrophthalic anhydride, methyl nadic anhydride, pyromellitic anhydride, dodecenylsuccinic anhydride, dichlorosuccinic anhydride, benzophenonetetracarboxylic anhydride, and chlorendic anhydride.

The amide compounds include, for example, dicyandiamide (DCDA) and polyamide.

The hydrazide compounds include, for example, adipic dihydrazide.

The imidazole compounds include, for example, methyl imidazole, 2-ethyl-4-methyl imidazole, ethyl imidazole, isopropyl imidazole, 2,4-dimethylimidazole, phenyl imidazole, undecylimidazole, heptadecylimidazole and 2-phenyl-4-methylimidazole.

The imidazoline compounds include, for example, methylimidazoline, 2-ethyl-4-methylimidazoline, ethylimidazoline, isopropylimidazoline, 2,4-dimethylimidazoline, phenylimidazoline, undecylimidazoline, heptadecylimidazoline and 2-phenyl-4-methyl imidazoline.

These curing agents can be used alone or in combination of two or more kinds.

Preferably, an amine compound and an amide compound are used together.

The curing agent is blended in a proportion of, for example, 1 to 15 parts by weight, or preferably 2 to 12 parts by weight, per 100 parts by weight of the modified epoxy resin.

In addition to the above-mentioned components, additives such as a coloring agent (pigment), a curing accelerator, and a foaming auxiliary agent, a processing auxiliary agent, a stabilizer, a plasticizer, an antiaging agent, an antioxidant, a mildewproofing agent, and a flame retardant can be added to the filling foam composition.

The coloring agents include, for example, carbon black and acetylene black. The coloring agent is blended in a proportion of, for example, 0.05 to 10 parts by weight per 100 parts by weight of the modified epoxy resin.

The curing accelerators include, for example, urea compounds (e.g., methylenediphenyl bisdimethyl urea, etc.), and phosphine compounds. Of these, a urea compound is preferably used. The curing accelerator is blended in a proportion of, for example, 0.2 to 5 parts by weight per 100 parts by weight of the modified epoxy resin.

These additives can be used alone or in combination of two or more kinds.

The filling foam composition can be obtained by blending each of the above-mentioned components in the above-mentioned mixing proportions, and can be prepared in the form of kneaded material by kneading the blended components at a temperature of 80 to 120° C., for example, by using a mixing roll, a pressure kneader, or an extruder, though not particularly limited thereto.

Thereafter, the kneaded material thus obtained is molded into a sheet form at a temperature of, for example, 60 to 150° C., or preferably 70 to 130° C., by calendaring, extrusion, or press molding.

The thickness of the sheet of the filling foam composition (a filling foam member described later) is appropriately selected according to the distance of a gap between members, or the foaming ratio of the sheet, and ranges, for example, 0.2 to 3.0 mm, or preferably 0.5 to 2.5 mm.

Thereafter, if necessary, the molded sheet of a filling foam composition is trimmed (cut) into the size of a given shape according to the size of the member.

The filling foam composition of the present invention thus obtained has a heat sagged length in (1) heat sag test explained below, of 14 mm or less, preferably 11 mm or less, or more preferably 8 mm or less, and usually 0.1 mm or more.

On the other hand, when the heat sagged length in (1) heat sag test exceeds the above range, the filling foam composition cannot have excellent heat sagging resistance, and heat sagging during heating cannot sufficiently be suppressed. As a result, the gap between members cannot be uniformly and reliably filled with a foam.

(1) Heat Sag Test

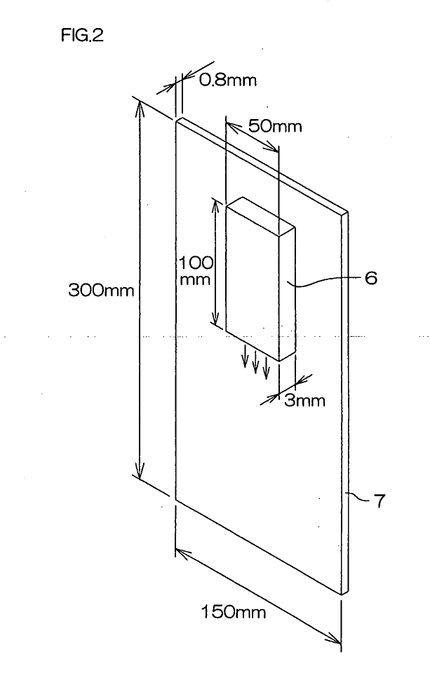

As shown in FIG. 2, a filling foam composition is processed into a rectangular sheet shape having a thickness of 3 mm, a length of 100 mm, and a width of 50 mm, to obtain a test piece 6.

Subsequently, the test piece 6 is adhered to one lengthwise side surface of a cold rolled steel plate 7 having a rectangular sheet shape of a length of 300 mm and a width of 150 mm via an adhesive tape (not shown). A 2 kg roller (not shown) is then reciprocated on the test piece 6 once along the lengthwise direction, and the test piece 6 is allowed to stand for 30 minutes.

Thereafter, the test piece 6 and the cold rolled steel plate 7 are mounted in a hot air dryer so that the lengthwise direction of the test piece 6 lies along the vertical direction and that the test piece 6 is positioned in the upper portion of the cold rolled steel plate 7, and are then heated at 150° C. for 30 minutes.

After the heated test piece 6 is air-cooled to room temperature, the length of the lower edge of the test piece 6 sagged downward is measured.

The filling foam composition of the present invention does not have any breakage caused by (2) Impact Test explained below.

On the other hand, when having a breakage caused by (2) Impact Test, the filling foam composition cannot have excellent impact resistance, failing to prevent the filling foam composition from being damaged due to vibration or dropping during transportation before attachment to a member or during the attachment. As a result, the sheet cannot be securely attached to a member while reliably maintaining its given shape.

(2) Impact Test

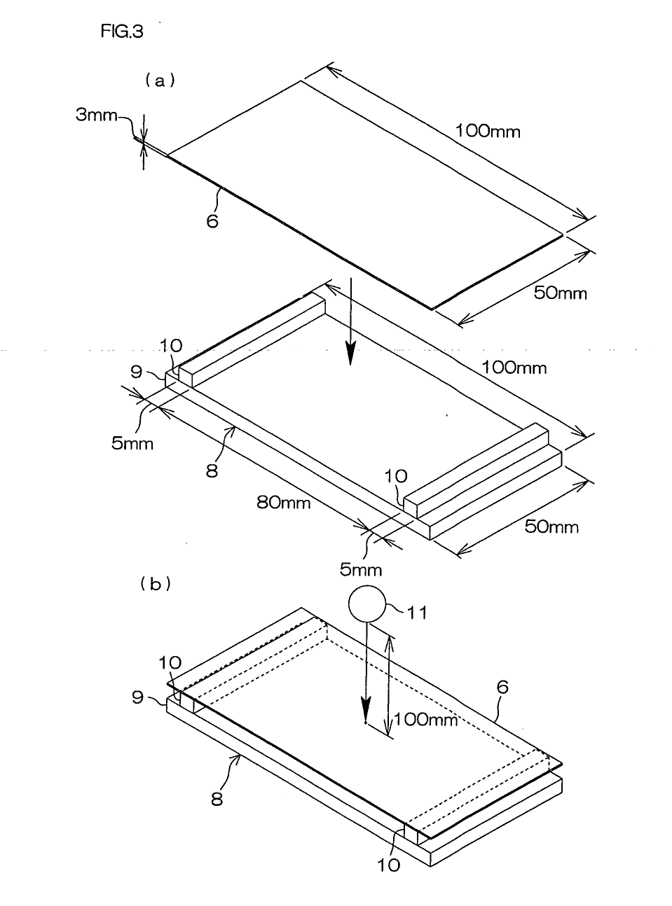

As shown in FIG. 3, a filling foam composition is processed into a rectangular sheet shape having a thickness of 3 mm, a length of 100 mm, and a width of 50 mm, to obtain a test piece 6.

A test stand 8 provided with a underplate 9 having the same length and the same width as the test piece 6 and two ridges 10 protruded upward from the underplate 9 in the thickness direction is prepared separately.

The two ridges 10 are opposed to each other at a spaced interval of 80 mm in the lengthwise direction, and extends in parallel along the widthwise direction (the direction orthogonal to the protruded direction of the ridges 10 and to the opposed direction thereof) of the test piece 6, each of the ridges 10 being formed in the shape of a rectangular cross-sectional beam having a length of 10 mm in the protruded direction, a length of 5 mm in the opposed direction, and a widthwise length of 50 mm.

Subsequently, as shown by the arrow of FIG. 3(a) and in FIG. 3(b), the test piece 6 is placed on the upper surfaces of the two ridges 10 on the test stand 8 so as to be disposed in the same position as the underplate 9 in plan view (when projected in the thickness direction).

Next, an iron ball 11 weighing 110 g is let fall from 10 cm above the center of the upper surface of the test piece 6, and the presence or absence of breakage of the test piece 6 is observed.

A foam foamed by heating the above-mentioned filling foam composition can be used for reinforcement of various kinds of members. Therefore, the foam can be suitably used as a filler for various industrial products such as a reinforcer filled in gap between various kinds of members.

The method for filling the gap between members is not particularly limited, and for example, a foam is formed by mounting the filling foam composition between members intended for filling a gap, and then heating to foam the mounted filling foam composition.

More specifically, for example, the gap between the members is filled in the following manner. First, a mounting member is mounted on a filling foam composition to produce a foam filling member. The foam filling member is then attached to a member through the mounting member, and the foam filling member is foamed by heating, to thereby form a foam.

As such member, a steel plate of an automobile body can be preferably exemplified. That is, after the foam filling member made of the filling foam composition of the present invention is produced and is then attached to a steel plate, when foamed, the steel plate can be reinforced with the foam.

Next, as an example of the embodiment of the filling foam composition and the foam filling member of the present invention, a method for filling a gap between steel plates will be described below.

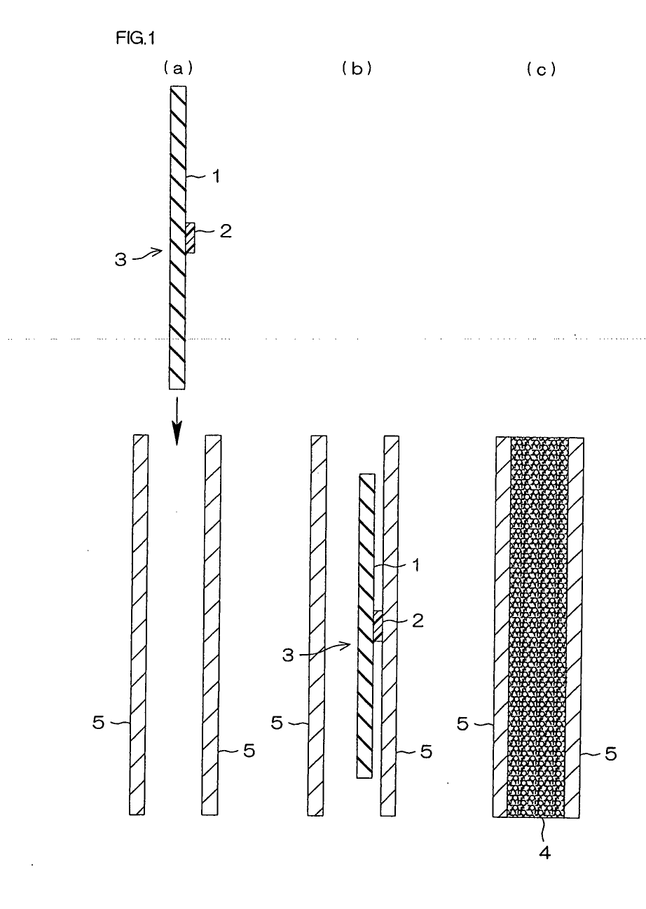

In this method, a foam filling member 3 is first prepared, as shown in the upper figure of FIG. 1(a).

The foam filling member 3 includes a filling foam member 1 formed of the above-mentioned filling foam composition, and a mounting member 2 mounted on the filling foam member 1.

The filling foam member 1 is molded in the above-mentioned sheet shape.

The mounting member 2 is formed of, for example, a non-foamable composition which is not foamed with heat. The non-foamable compositions that may be used include, for example, heat-resistant resins such as nylon and polyester; and metals such as iron (including magnetite (magnet material)) and stainless steel.

Specifically, the mounting member 2 is a clip, a sucker, or a magnet. For example, the mounting member 2 is mounted on one side of the thickness direction of the filling foam member 1, and is configured to be attachable to at least one of two steel plates 5.

To mount the mounting member 2 to the filling foam member 1, the mounting member 2 is attached to a sheet of the filling foam composition described above (filling foam member 1), and as the other process, the mounting member 2 can be insert-molded together with the filling foam composition during the molding into the filling foam member 1.

As shown in the lower figure of FIG. 1(a), two steel plates 5 are separately prepared as members.

The two steel plates 5 are disposed in spaced relation to each other so that a gap is formed therebetween and are each formed in a plate-like shape.

Specifically, these two steel plates 5 are portions equivalent to pillars of an automobile.

As shown in FIG. 1(b), the mounting member 2 is attached to the inner surface of one steel plate 5 (a surface opposed to the other steel plate 5).

To attach the mounting member 2 to the inner surface of one steel plate 5, as indicated by the arrow of FIG. 1(a), the foam filling member 3 is inserted into between the two steel plates 5.

Along with this, for example, when the mounting member 2 is a clip, a fixing groove is preliminarily formed in the inner surface of one steel plate 5, and the mounting member 2 is inserted into the fixing groove, to thereby fix the foam filling member 3 to one steel plate 5. Alternatively, when the mounting member 2 is a sucker or a magnet, an adhesion force or a magnetic force of the mounting member 2 may be applied to fix the foam filling member 3.

Thereafter, in this method, using heat in a drying line process during subsequent baking finish, the steel plates 5 are heated at a temperature of, for example, 150° C. to 180° C., or preferably 160° C. to 175° C. As shown in FIG. 1(c), this allows a foam 4 to be formed by foaming the filling foam member 1, and this foam 4 can fill a gap between the steel plates 5.

A volume foaming ratio (density before foaming/density after foaming) of the foam 4 thus foamed is in the range of, for example, 1.2 to 5 times, or preferably 1.5 to 2.5 times.

The shape, mounting position, disposition orientation, number of disposition and the like of the filling foam member 1 are appropriately selected according to the shape of the steel plate 5 and the portion where the steel plates are disposed.

The filling foam member 1 formed of the above-mentioned filling foam composition has excellent impact resistance.

Therefore, such property can prevent the filling foam member 1 from being damaged due to vibration or dropping during transportation before attachment to the steel plate 5 or during the attachment, thereby allowing its sheet shape to be reliably maintained and to be securely attached to the steel plate 5. As a result, the foam 4 can be reliably filled in the gap between the two steel plates 5 with heating.

The filling foam member 1 formed of the above-mentioned filling foam composition has excellent heat sagging resistance.

Therefore, heat sagging during heating is suppressed, and the foam 4 can be uniformly and reliably filled in the gap between the two steel plates 5.

Further, the above-mentioned foam filling member 3 allows the foam 4 of the filling foam member 1 made of the filling foam composition, which is excellent in impact resistance and heat sagging resistance, to uniformly and reliably fill the gap between the two steel plates 5.

### EXAMPLES

### Examples 1 to 3 and Comparative Examples 1 to 5

According to the blending formulation shown in Table 1, the filling foam composition of each of Examples and Comparative Examples was kneaded at a temperature of 80 to 120° C. for 10 minutes using a 6-inch mixing roll. Subsequently, the kneaded mixture was press-molded with a hot press at 80° C. to form into a 3 mm-thick sheet. Thereafter, the sheet was trimmed into the shape of a rectangular sheet having a length of 100 mm and a width of 50 mm, to thereby obtain a rectangular sheet shaped test piece (6) (see FIGS. 2 and 3).

(Evaluation)

(1) Heat Sag Test (see FIG. 2)

The test piece (6) was adhered to one lengthwise side surface of a cold rolled steel plate (0.8 mm in thickness, manufactured by Nippon Testpanel Co., Ltd.) (7) having a rectangular sheet shape of a length of 300 mm and a width of 150 mm via a double-sided adhesive tape (trade name “No. 5000NS”, manufactured by NITTO DENKO CORPORATION). A 2 kg roller was then reciprocated on the test piece (6) once along the lengthwise direction, and the test piece (6) was allowed to stand at room temperature for 30 minutes.

Thereafter, the test piece (6) and the cold rolled steel plate (7) were mounted in a hot air dryer at 150° C. so that the lengthwise direction of the test piece 6 lay along the vertical direction and that the test piece (6) was positioned in the upper portion of the cold rolled steel plate (7), and was then heated for 30 minutes.

After the heated test piece (6) was air-cooled to room temperature, the length of the lower edge of the test piece (6) sagged downward was measured.

The results are shown in Table 1.

(2) Impact Test (see FIG. 3)

A test stand (8) provided with a rectangular shaped underplate (9) made of stainless steel having a thickness of 10 mm, a length of 100 mm, and a width of 50 mm, and two ridges (10) made of stainless steel protruded from the underplate (9) upward in the thickness direction was prepared.

The two ridges (10) were opposed to each other at a spaced interval of 80 mm in the lengthwise direction, and extended in parallel along the widthwise direction of the underplate (9), each of the ridges (10) being formed in the shape of a rectangular cross-sectional beam having a length of 10 mm in the protruded direction, a length of 5 mm in the opposed direction, and a widthwise length of 50 mm.

Thereafter, the test piece (6) was placed on the upper surfaces of the two ridges (10) on the test stand (8) so as to be disposed in the same position as the underplate (9) in plan view.

Next, an iron ball (11) weighing 110 g is let fall from 10 cm above the center of the upper surface of the test piece (6), and the presence or absence of breakage of the test piece (6) is observed.

The results are shown in Table 1.

(3) Volume Foaming Ratio

Each of the test pieces thus obtained was foamed by heating at 150° C. for 30 minutes, and the volume expansion ratio of the foamed test piece was determined. The results are shown in Table 1.

TABLE 1

| | | | | Ex. & Comp. Ex. | | | | | | | |
|---|---|---|---|---|---|---|---|---|---|---|---|
| | | | | | | | Comp. | Comp. | Comp. | Comp. | Comp. |
| | | | | Ex. 1 | Ex. 2 | Ex. 3 | Ex. 1 | Ex. 2 | Ex. 3 | Ex. 4 | Ex. 5 |
| Filling Foam | Modified Epoxy Resin | | p/wt | 120.0 | 200.0 | 90.0 | — | 120.0 | — | 200.0 | 90.0 |
| Composition | | | (parts by | (40.2) | (52.8) | (33.5) | | (40.4) | | (53.1) | (33.7) |
| Formula | | | weight/vs 100 | | | | | | | | |
| | | | parts by weight of | | | | | | | | |
| | | | filling foam | | | | | | | | |
| | | | composition) | | | | | | | | |
| | Fiber | Aromatic Polyamide | p/wt | 2.0 | 2.0 | 2.0 | 2.0 | — | — | — | — |
| | | Fiber | | | | | | | | | |
| | Resin | Bisphenol A Type | p/wt | — | — | — | 120.0 | — | 120.0 | — | — |
| | | Epoxy Resin | | | | | | | | | |
| | | Hydrogenated | p/wt | 12.0 | 12.0 | 12.0 | 12.0 | 12.0 | 12.0 | 12.0 | 12.0 |
| | | Bisphenol A | | | | | | | | | |
| | | Type Epoxy resin | | | | | | | | | |
| | | EVA | p/wt | 15.0 | 15.0 | 15.0 | 15.0 | 15.0 | 15.0 | 15.0 | 15.0 |
| | Filler | Calcium Carbonate | p/wt | 140.0 | 140.0 | 140.0 | 140.0 | 140.0 | 140.0 | 140.0 | 140.0 |
| | Foaming | OBSH | p/wt | 1 | 1 | 1 | 1 | 1 | 1 | 1 | 1 |
| | Agent | | | | | | | | | | |
| | Curing | DCDA | p/wt | 4 | 4 | 4 | 4 | 4 | 4 | 4 | 4 |
| | Agent | 12-Aminododecanoic | p/wt | 3 | 3 | 3 | 3 | 3 | 3 | 3 | 3 |
| | | Acid | | | | | | | | | |
| | Coloring | Carbon Black | p/wt | 0.2 | 0.2 | 0.2 | 0.2 | 0.2 | 0.2 | 0.2 | 0.2 |
| | Agent | | | | | | | | | | |
| | Curing | Methylenediphenyl | p/wt | 1.5 | 1.5 | 1.5 | 1.5 | 1.5 | 1.5 | 1.5 | 1.5 |
| | Accelerator | Bisdimethyl Urea | | | | | | | | | |

| | | | | | | | | | | |
|---|---|---|---|---|---|---|---|---|---|---|
| Evaluation | Heat Sag Test | mm | 7 | 8 | 2 | 9 | 60 | >100 | 58 | 15 |
| | Impact Test | Presence/ | Absent | Absent | Absent | Present | Absent | Present | Absent | Absent |
| | | Absence | | | | | | | | |
| | | of Breakage | | | | | | | | |
| | Volume Foaming Ratio | Foaming | 1.7 | 2.0 | 1.6 | 1.7 | 1.8 | 1.8 | 2.0 | 1.5 |
| | | Temperature: | | | | | | | | |
| | | 150□Z | | | | | | | | |

The details of each component in Table 1 will be described below.

Modified epoxy resin: Rubber-modified epoxy resin in which bisphenol A type epoxy resin has been modified with carboxyl terminal acrylonitrile-butadiene copolymer, epoxy equivalent of 1200 to 1800 g/eqiv.

Aromatic polyamide fiber: Poly (p-phenyldiamine terephthalamide), density: 1.41 g/cm³, mean fiber length: 1.7 mm, Young's modulus: 58.8 GPa

Bisphenol A type epoxy resin: Solid form, epoxy equivalent of 450 to 500 g/eqiv.

Hydrogenated bisphenol A type epoxy resin: Liquid form, epoxy equivalent of 240 g/eqiv.

EVA: Product name “Elvax240”, ethylene-vinyl acetate copolymer, vinyl acetate content: 28% by weight, manufactured by DuPont

Calcium carbonate: Calcium carbonate heavy, manufactured by Maruo Calcium Co., Ltd.

OBSH: Product name “NEOCELLBORN N #1000S”, 4,4′-oxybis(benzenesulphonylhydrazide), manufactured by Eiwa Chemical Ind. Co., Ltd.

DCDA: Product name: DDA50, dicyandiamide, manufactured by PTI Japan

Carbon black: Product name “Asahi Carbon #50”, manufactured by Asahi Carbon Co., Ltd.

While the illustrative embodiments of the present invention are provided in the above description, such is for illustrative purpose only and it is not to be construed restrictively. Modification and variation of the present invention that will be obvious to those skilled in the'art is to be covered by the following claims.

What is claimed is:

1. A filling foam composition for filling a gap between members by foaming,
having a heat sagged length of 14 mm or less in the following (1) heat sag test,
without any breakage caused by the following (2) impact test:
(1) Heat Sag Test
The filling foam composition is processed into a rectangular sheet shape having a thickness of 3 mm, a length of 100 mm, and a width of 50 mm, to obtain a test piece.
Subsequently, the test piece is adhered to one lengthwise side surface of a cold rolled steel plate having a rectangular sheet shape of a length of 300 mm and a width of 150 mm via an adhesive tape. A 2 kg roller is then reciprocated on the test piece once along the lengthwise direction, and the test piece is allowed to stand for 30 minutes.
Thereafter, the test piece and the cold rolled steel plate are disposed so that the lengthwise direction of the test piece lies along the vertical direction and that the test piece is positioned in the upper portion of the cold rolled steel plate, and then are heated at 150° C. for 30 minutes.
After the heated test piece is air-cooled to room temperature, the length of the lower edge of the test piece sagged downward is measured.
(2) Impact Test
The filling foam composition is processed into a rectangular sheet shape having a thickness of 3 mm, a length of 100 mm, and a width of 50 mm, to obtain a test piece.
A test stand provided with a underplate having the same length and the same width as the test piece and two ridges protruded upward from the underplate in the thickness direction is prepared separately. The two ridges are opposed to each other at a spaced interval of 80 mm in the lengthwise direction, and extends in parallel along the widthwise direction orthogonal to the protruded direction and to the opposed direction, each of the ridges being formed in the shape of a rectangular cross-sectional beam having a length of 10 mm in the protruded direction, a length of 5 mm in the opposed direction, and a widthwise length of 50 mm.
Thereafter, the test piece is placed on the upper surfaces of the two ridges on the test stand so as to be disposed in the same position as the underplate when projected in the thickness direction.
Next, an iron ball weighing 110 g is let fall from 10 cm above the center of the upper surface of the test piece, and the presence or absence of breakage of the test piece is observed.

2. The filling foam composition according to claim 1, comprising a modified epoxy resin and fiber.

3. The filling foam composition according to claim 2, wherein the modified epoxy resin is one obtained by modifying a bisphenol A type epoxy resin with a carboxyl terminal acrylonitrile-butadiene copolymer.

4. The filling foam composition according to claim 2, wherein the fiber is an aromatic polyamide fiber.

5. The filling foam composition according to claim 2, wherein the modified epoxy resin is blended in a proportion of 20 to 70 parts by weight per 100 parts by weight of the filling foam composition.

6. The filling foam composition according to claim 2, further comprising a resin except a modified epoxy resin.

7. The filling foam composition according to claim 6, wherein the resin is an ethylene-vinyl acetate copolymer and/or an epoxy resin.

8. The filling foam composition according to claim 6, wherein the resin is blended in a proportion of 5 to 40 parts by weight per 100 parts by weight of the modified epoxy resin.

9. The filling foam composition according to claim 1, wherein the member is a steel plate of an automobile.

10. A foam filling member comprising:
a filling foam member made of a filling foam composition for filling a gap between members by foaming; and
a mounting member mounted on the filling foam member, attachable to the gap between members and made of a non-foamable composition which is not foamed with heat,
wherein the filling foam composition has a heat sagged length of 14 mm or less in the following (1) heat sag test,
without any breakage caused by the following (2) impact test:
(1) Heat Sag Test
The filling foam composition is processed into a rectangular sheet shape having a thickness of 3 mm, a length of 100 mm, and a width of 50 mm, to obtain a test piece.
Subsequently, the test piece is adhered to one lengthwise side surface of a cold rolled steel plate having a rectangular sheet shape of a length of 300 mm and a width of 150 mm via an adhesive tape. A 2 kg roller is then reciprocated on the test piece once along the lengthwise direction, and the test piece is allowed to stand for 30 minutes.
Thereafter, the test piece and the cold rolled steel plate are disposed so that the lengthwise direction of the test piece lies along the vertical direction and that the test piece is positioned in the upper portion of the cold rolled steel plate, and then are heated at 150° C. for 30 minutes.
After the heated test piece is air-cooled to room temperature, the length of the lower edge of the test piece sagged downward is measured.
(2) Impact Test
The filling foam composition is processed into a rectangular sheet shape having a thickness of 3 mm, a length of 100 mm, and a width of 50 mm, to obtain a test piece.
A test stand provided with a underplate having the same length and the same width as the test piece and two ridges protruded upward from the underplate in the thickness direction is prepared separately. The two ridges are opposed to each other at a spaced interval of 80 mm in the lengthwise direction, and extends in parallel along the widthwise direction orthogonal to the protruded direction and to the opposed direction, each of the ridges being formed in the shape of a rectangular cross-sectional beam having a length of 10 mm in the protruded direction, a length of 5 mm in the opposed direction, and a widthwise length of 50 mm.
Thereafter, the test piece is placed on the upper surfaces of the two ridges on the test stand so as to be disposed in the same position as the underplate when projected in the thickness direction.
Next, an iron ball weighing 110 g is let fall from 10 cm above the center of the upper surface of the test piece, and the presence or absence of breakage of the test piece is observed.
